(19) United States
(12) Patent Application Publication
(10) Pub. No.: US 2019/0303823 A1
(43) Pub. Date: Oct. 3, 2019

(54) COMPUTER IMPLEMENTED SYSTEM FOR REQUEST MANAGEMENT WITHIN AN ORGANIZATION

(71) Applicant: Zycus Infotech Pvt. Ltd., Mumbai (IN)

(72) Inventors: Vijesh Bhakta, Mumbai (IN); Nikhil Mehta, Mumbai (IN)

(73) Assignee: Zycus Infotech Pvt. Ltd., Mumbai (IN)

(21) Appl. No.: 16/137,996

(22) Filed: Sep. 21, 2018

(30) Foreign Application Priority Data
Mar. 28, 2018 (IN) 201821011629

(51) Int. Cl. G06Q 10/06

(52) U.S. Cl. CPC G06Q 10/06311

(57) ABSTRACT

A centralized, computer implemented system is provided for request management within an organization, wherein the request management system is capable of performing the following functions: gathering user generated requests; sorting user generated requests; prioritising the requests; transferring the requests to the necessary person/department; updating the requester with the status of the request; linking related documents; matching requests relating to the same and/or similar items; and rejecting requests which are in violation of any pre-configured rules/limits.

### CROSS-REFERENCE TO RELATED APPLICATION

The instant application claims priority to Indian Patent Application Serial No. 201821011629, filed Mar. 28, 2018, pending, the entire specification of which is expressly incorporated herein by reference.

### FIELD OF THE INVENTION

The present invention discloses a computer implemented system that manages, prioritizes and responds to requests generated by the members of an organization.

### BACKGROUND OF THE INVENTION

In any organization, most day to day functioning requires that an employee of the company raise a request in order to have some task performed. In general, this request would be routed to a central server where it would be manually read, prioritized and conveyed to the concerned department/personnel. This is a tedious and time consuming task that is prone to error on the part of the admin/manager responsible for managing the high volume of requests.

For example, most organizations have a very large number of employees—in the tens of thousands. Consequently, there will be a huge volume of employee requests generated daily. Requests may range from requesting stationary from the store/requesting a cab/printer/food, etc. to more time sensitive requests such as faxing documents to a client/requesting IT support/raising a PO, etc. Managing this large influx of employee generated requests manually (by an admin or request manager) becomes a time consuming and tedious task. The admin/manager would be required to log into the request management software, personally peruse each and every request, prioritize the requests, forward each request to the concerned department based on urgency and priority status and then track the progress of each request.

Clearly, this task is highly prone to errors when performed manually (for example, urgent requests may be overshadowed by less urgent ones, which could lead to severe consequences) and prioritizing of requests becomes a challenge. There is a need for a centralized software program that can manage the influx of employee requests (i.e., prioritize, delegate and follow up on the status of each). The present invention describes such a computer implemented system that can be used for management of requests effectively.

U.S. Patent Publication No. 20020124184 provides a method of request authorization and authority management, provided with at least a requestor-operated interface, having at least a display device and input device, and server, having at least a processor and a memory device. The system comprises at least one interface, having at least a display and data input means, and a server. To initiate the process, the user selects or “clicks” on an application icon shown on the user's display. The server generates a request form on the user's display which is completed by the user with the required information and request parameters. The user's request preferences can be simply stored on the server in a profile document that is later accessed for generating repeat or similar requests. A server database serves as a data store to store all of the requests and allows users the opportunity to check the status of their requests.

U.S. Pat. No. 6,832,202 provides a method and system of routing requests for authorized approval that substantially reduce or eliminate problems associated with prior systems and methods as well as improving the movement of work by automating manual tasks. In accordance with the present invention, a method and system for routing requests for authorized approval may comprise automatically determining approvals required for authorization of a request. A valid agent to provide one of the approvals required for authorization of the request may be determined. The requests may be automatically routed to the valid agent for approval. After approval, it may be automatically determined if the approvals required for authorization of the request have been obtained.

None of the current prior art provides for a system that can be internally linked with the other software applications in use by the organization using the request management system. The present invention allows the request management system to link with such other applications, thus allowing for internal processing of the request with absolutely no manual interference required.

### SUMMARY OF THE INVENTION

An objective of the present invention is to provide a computer implemented system that can be used for the management of employee generated requests in an organization.

Another objective of the present invention is to provide a computer implemented system for the management of employee generated requests in an organization wherein the system is interlinked with other software applications used by the company, so as to efficiently perform the order in the request.

In accordance with the general teachings of the present invention, there is provided a novel, centralized, computer implemented system that manages the employee requests in an organization.

In accordance with one embodiment of the present invention, a centralized, computer implemented system is provided for request management within an organization, wherein the request management system is capable of performing the following functions:

gathering user generated requests;

sorting user generated requests;

prioritising the requests;

transferring the requests to the necessary person/department;

updating the requester with the status of the request;

linking related documents;

matching requests relating to the same and/or similar items; and

rejecting requests which are in violation of any pre-configured rules/limits.

In accordance with one aspect of this embodiment, the system can be linked to other software applications used in the organization, including but not limited to applications for procurement, sourcing, contract management, project management, financial savings management, supplier management, travel management, etc.

In accordance with one aspect of this embodiment, the system can be accessed from a plurality of input/output devices, including but not limited to mobile devices and computer systems.

In accordance with one aspect of this embodiment, a user raises a request by filling a webform.

In accordance with one aspect of this embodiment, the system is preconfigured with decision rules which allow the system to accurately perform the gathering, sorting, prioritising, transferring and updating of requests.

In accordance with one aspect of this embodiment, the rules can be customized and may include category and sub-category of request, type and sub-type of request, requests related to customer deliverables, requests marked for urgent manufacturing deliverables, amongst other criteria.

In accordance with one aspect of this embodiment, the system is interactive in that it is capable of requesting input from the user, accepting the input from the user and acting accordingly.

In accordance with one aspect of this embodiment, the system is capable of making analytical decisions pertaining to, but not limited to prioritising requests, rejecting requests, and matching similar/same requests from multiple users.

In accordance with one aspect of this embodiment, the system is capable of comparing multiple requests by comparing the fields present in the webform of each request.

In accordance with one aspect of this embodiment, the system updates the user of the status of the user's request.

In accordance with one aspect of this embodiment, the system possesses a link document feature which links together related documents so as to simplify the tracking, accessing and obtaining of interrelated information.

In accordance with one aspect of this embodiment, the feature performs the linking of related documents by mapping the IDs of the related documents.

In accordance with one aspect of this embodiment, the feature allows the user to link two or more documents.

In accordance with one aspect of this embodiment, the system possesses a scrutiny/de-duplication check module to reject requests in violation of any pre-configured limits.

In accordance with one aspect of this embodiment, the system possesses a matching feature, which matches multiple requests pertaining to the same or similar items.

### DETAILED DESCRIPTION OF THE INVENTION

Before the present invention is described, it is to be understood that this invention is not limited to particular methodologies described, as these may vary as per the person skilled in the art. It is also to be understood that the terminology used in the description is for the purpose of describing the particular embodiments only, and is not intended to limit the scope of the present invention.

Throughout this specification, the word “comprise”, or variations such as “comprises” or “comprising”, will be understood to imply the inclusion of a stated element, integer or step, or group of elements, integers or steps, but not the exclusion of any other element, integer or step, or group of elements, integers or steps. The use of the expression “at least” or “at least one” suggests the use of one or more elements or ingredients or quantities, as the use may be in the embodiment of the invention to achieve one or more of the desired objects or results.

As previously noted, most aspects of day to day functioning in an organization require that an employee raise a request so as to have some task performed. For example, an employee may request any of the following—procurement of an item, obtaining contract information, creation of a sourcing event, obtaining stationary/cab/gate pass/travel arrangements/printed documents/photocopies, request for IT support, request for the review of a document by legal, request for raising a PO, request for courier of a parcel, amongst other requests. Generally, this task is performed manually by an admin/manager in charge of the requests. Sorting, prioritizing and tracking all the requests manually is an error prone task when performed manually.

The present invention describes a novel, computer implemented system that is capable of management of employee requests in a timely and efficient manner. The system is henceforth referred to as the “iRequest” system.

iRequest is a centralized software that can be linked to the various other software applications that the company is using. These may include applications for procurement, sourcing, contract management, project management, financial savings management, supplier management, travel management, etc. This allows the iRequest system to carry out further processing of the request after receiving it, by forwarding the request to the concerned department.

iRequest is designed such that it can be accessed from a plurality of input/output devices including mobile devices and computer systems. The process of raising a request is simple—the user simply needs to fill out a web form, wherein a webform is an interactive online page which allows for user input (in this case, the user input being the request). The system has an automated request manager which screens all the requests. The request manager is preconfigured with decision rules to gather, prioritize and process various requests. The decision rules are customizable and may include category and sub-category of request, type and sub-type of request, requests related to customer deliverables, requests marked for urgent manufacturing deliverables, etc. The decision rules are continually revamped based on heuristic patterns and self-learning analytics (described in the following paragraph).

The system is interactive and capable of making analytical decisions. This means that even if a user marks a request as urgent, the system evaluates the “urgency” of the request itself. For example, if an employee has requested a new laptop and has marked the request as urgent, the system sends out an auto-generated question to the employee asking whether the employee has an alternate system on which to work. If the employee responds ‘yes’, the system will not classify the request as urgent; but if the employee responds ‘no’, the system will recognize the request as urgent and prioritize it. Hence the system is said to be self-learning. The system performs such analysis based on several factors, some of which include category and/or sub-category of request, whether the request concerns customer deliverables, whether the request is for manufacturing deliverables, etc.

In order to analyze and prioritize various requests, the system is able to compare them. The system does this by comparing the fields present in the webform of one request with those in the webform of another request. For example, if one request has the field “supplier” and the other has the field “customer”, the system will prioritize one of them based on the preconfigured, customized decision rules mentioned previously.

Once the requests have been gathered and prioritized, the system sends the request to the concerned software application to which it is connected. For example, a contract related request will be channelized to the contract management software. The system also keeps the requester updated on the status of the request through the link document feature. This feature helps the user link all procurement objects and related objects (such as contract PO, invoice, requisition, etc.) so as to simplify the tracking, accessing and obtaining of interrelated information. With this feature, the user can link the spend report with the RFQ event, the contract and all related PRs, POs and invoices. Subsequently, when the user opens any one of these objects, he/she can see links to the other related objects on the same webpage, in a collapsible panel. Linking is done based on mapping of IDs of related procurement objects. A user can link two procurement objects by clicking on ‘New Link’ button (on the header of linking notification panel) from a pop up. Using the “Link More” option, the user can link more than two objects. Further, the user can see all linking activity notifications on this panel in the form of a list. The company admin can customize and roll out the visibility of a linking activity to the users employees through a “linking admin panel”. The user gets to see latest three notifications on his/her home page on this panel. To see the entire history of linking notifications, he/she can click view all and navigate to a new webpage where all the listing notifications are displayed in a timeline format.

When the user navigates to view a procurement object, he/she gets to see all the procurement objects linked to it, in a panel called ‘Linked Procurement Objects’. This is a context sensitive panel, meaning that it understands the context (i.e., which procurement object is currently being viewed by the user) and automatically renders the associated linked procurement objects. The user can navigate to the linked procurement objects by clicking on the links that would lead to them.

iRequest also possesses a scrutiny/de-duplication check module to reject any request, if that request is in violation of any preconfigured approval limit, threshold or upper cap. It may reject a request in case of supplier conflict or to save time and cost to the company. This feature of the system can be illustrated through the following examples. An employee may raise a request stating ‘Need a new laptop of ABC company’. The iRequest system (using the link document feature described previously) will scan through all contracts and documents related to purchase and acquisition of new hardware (specifically laptops). During this scan, if the system detects a contract with a company other than ABC (say company XYZ) for the purchase of laptops, the system will reject the request for an ABC laptop. It will instead take the steps necessary to provide the requester with a new laptop of XYZ company. In another scenario, a user may have requested 10 new units of hardware. The system will check accounts and billing information to verify whether the request is within the sanctioned limit for that department/individual. If it is within the limit, it will proceed with the request; if it is not in the limit, it will reject the request.

Another module of the iRequest system allows for the matching of requests which pertain to the same or similar items (wherein these requests may be from different departments/locations). An advantage of this feature is that it may help the company to avail of bulk discounts from suppliers, rather than incur the higher costs associated with purchasing single units separately.

The novel, centralized, computer implemented system for managing employee requests described in this disclosure overcomes the problems associated with manual request management. It provides for a simple and effective solution for error-free gathering, prioritization and tracking of employee requests.

In some applications, the present invention described above may be provided as elements of an integrated software system, in which the features may be provided as separate elements of a computer program. Some embodiments may be implemented, for example, using a computer-readable storage medium (e.g., non-transitory) or article which may store an instruction or a set of instructions that, if executed by a processor, may cause the processor to perform a method in accordance with the embodiments. Other applications of the present invention may be embodied as a hybrid system of dedicated hardware and software components. Moreover, not all of the features described above need be provided or need be provided as separate units. Additionally, it is noted that the arrangement of the features do not necessarily imply a particular order or sequence of events, nor are they intended to exclude other possibilities. For example, the features may occur in any order or substantially simultaneously with each other. Such implementation details are immaterial to the operation of the present invention unless otherwise noted above.

The exemplary methods and computer program instructions may be embodied on a computer readable storage medium (e.g., non-transitory) that may include any medium that can store information. Examples of a computer readable storage medium (e.g., non-transitory) include electronic circuits, semiconductor memory devices, ROM, flash memory, erasable ROM (EROM), floppy diskette, CD-ROM, optical disk, hard disk, fiber optic medium, or any electromagnetic or optical storage device. In addition, a server or database server may include computer readable media configured to store executable program instructions. The features of the embodiments of the present invention may be implemented in hardware, software, firmware, or a combination thereof and utilized in systems, subsystems, components or subcomponents thereof.

Furthermore, a software program embodying the features of the present invention may be used in conjunction with a computer device or system. Examples of a computing device or system may include, but are not limited to, an electronic book reading device, a computer workstation, a terminal computer, a server computer, a handheld or mobile device (e.g., a tablet computer, a personal digital assistant “PDA”, a mobile telephone, a Smartphone, etc.), a web appliance, a network router, a network switch, a network bridge, any machine capable of executing a sequence of instructions that specify an action to be taken by that machine, and any combinations thereof. In one example, a computing device may include and/or be included in, a kiosk.

As used herein, the term “mobile device” is intended to encompass any form of programmable computing device as may exist, or will be developed in the future, that implements a communication module for wireless voice and data communications, including, for example, cellular telephones, personal data assistants (PDA's), palm-top computers, laptop, and notebook computers, wireless electronic mail receivers (e.g., the BLACKBERRY and TREO devices), multimedia Internet enabled cellular telephones (e.g., the BLACKBERRY STORM, and similar personal electronic devices that include a wireless communication module, processor and memory.

The computer device or system may also include an input device. In one example, a user of the computer device or system may enter commands and/or other information into computer device or system via an input device. Examples of an input device may include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. The input device may be interfaced to bus via any of a variety of interfaces including, but not limited to, a serial interface, a parallel interface, a game port, a USB interface, a FIREWIRE interface, a direct interface to bus, and any combinations thereof. The input device may include a touch screen interface that may be a part of or separate from the display.

A user may also input commands and/or other information to the computer device or system via a storage device (e.g., a removable disk drive, a flash drive, etc.) and/or a network interface device. A network interface device, such as network interface device may be utilized for connecting the computer device or system to one or more of a variety of networks and/or one or more remote devices connected thereto. Examples of a network interface device may include, but are not limited to, a network interface card (e.g., a mobile network interface card, a LAN card), a modem, and any combination thereof. Examples of a network may include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software, etc.) may be communicated to and/or from the computer device or system via a network interface device.

The computer device or system may further include a video display adapter for communicating a displayable image to a display device, such as a display device. Examples of a display device may include, but are not limited to, a liquid crystal display (LCD), a cathode ray tube (CRT), a plasma display, a light emitting diode (LED) display, and any combinations thereof. In addition to a display device, the computer device or system may include one or more other peripheral output devices including, but not limited to, an audio speaker, a printer, and any combinations thereof. Such peripheral output devices may be connected to a bus via a peripheral interface. Examples of a peripheral interface may include, but are not limited to, a serial port, a USB connection, a FIREWIRE connection, a parallel connection, and any combinations thereof.

What is claimed is:

1. A centralized, computer implemented system for request management within an organization, wherein the request management system is capable of performing the following functions:
gathering user generated requests;
sorting user generated requests;
prioritising the requests;
transferring the requests to the necessary person/department;
updating the requester with the status of the request;
linking related documents;
matching requests relating to the same and/or similar items; and
rejecting requests which are in violation of any pre-configured rules/limits.

2. The system as claimed in claim 1, wherein the system can be linked to other software applications used in the organization, including applications for procurement, sourcing, contract management, project management, financial savings management, supplier management, and travel management.

3. The system as claimed in claim 1, wherein the system can be accessed from a plurality of input/output devices, including mobile devices and computer systems.

4. The system as claimed in claim 1, wherein a user raises a request by filling a webform.

5. The system as claimed in claim 1, wherein the system is preconfigured with decision rules which allow the system to accurately perform the gathering, sorting, prioritising, transferring and updating of requests.

6. The system as claimed in claim 5, wherein the rules can be customized and may include category and sub-category of request, type and sub-type of request, requests related to customer deliverables, requests marked for urgent manufacturing deliverables, amongst other criteria.

7. The system as claimed in claim 1, wherein the system is interactive in that it is capable of requesting input from the user, accepting the input from the user and acting accordingly.

8. The system as claimed in claim 1, wherein the system is capable of making analytical decisions pertaining to prioritising requests, rejecting requests, and matching similar/same requests from multiple users.

9. The system as claimed in claim 1, wherein the system is capable of comparing multiple requests by comparing the fields present in the webform of each request.

10. The system as claimed in claim 1, wherein the system updates the user of the status of the user's request.

11. The system as claimed in claim 1, wherein the system possesses a link document feature which links together related documents so as to simplify the tracking, accessing and obtaining of interrelated information.

12. The system as claimed in claim 11, wherein the feature performs the linking of related documents by mapping the IDs of the related documents.

13. The system as claimed in claim 11, wherein the feature allows the user to link two or more documents.

14. The system as claimed in claim 1, wherein the system possesses a scrutiny/de-duplication check module to reject requests in violation of any pre-configured limits.

15. The system as claimed in claim 1, wherein the system possesses a matching feature, which matches multiple requests pertaining to the same or similar items.
